(19) United States
(12) Patent Application Publication
(10) Pub. No.: US 2017/0359507 A1
(43) Pub. Date: Dec. 14, 2017

(54) METHOD OF CONFIGURING AND ADJUSTING FRAME COVERAGE FOR ROTATABLE CAMERA

(71) Applicant: JSW Pacific Corporation, New Taipei City (TW)

(72) Inventors: Tsan-Hui LEE, New Taipei City (TW); Yin-Chung CHEN, New Taipei City (TW)

(21) Appl. No.: 15/274,111

(22) Filed: Sep. 23, 2016

(30) Foreign Application Priority Data
Jun. 13, 2016 (CN) 201610415363.0

(51) Int. Cl. H04N 5/232; H04N 7/18

(52) U.S. Cl. CPC H04N 5/23216; H04N 7/183; H04N 5/23296; H04N 5/23203; H04N 5/23238

(57) ABSTRACT

A method of configuring and adjusting frame coverage for a rotatable camera is provided. The method comprises following steps: a rotatable camera shoots a monitoring environment with different angles to generate a plurality of region images; combining the region images into a panoramic image; receiving an image-selecting operation for selecting a monitoring place in the panoramic image; retrieving an rotating angle information corresponding to the selected monitoring place and corresponding the rotating angle information to a triggering condition; and rotating the rotatable camera according to the rotating angle information for the current frame coverage of the rotatable camera to comprise the monitoring place when determining the triggering condition is satisfied.

### FIELD OF THE INVENTION

The present invention is related to a method of configuring and adjusting and more particularly related to a method of configuring and adjusting frame coverage for a rotatable camera.

### BACKGROUND OF THE DISCLOSURE

In current monitoring and shooting techniques, a rotatable camera with adjustable frame coverage is available. Specifically, when a user discovers a stranger in a monitoring screen, a rotatable camera can be operated manually to change the orientation of the camera shot and to change the frame coverage, so as to conduct monitoring to the position of the stranger.

In addition, such rotatable camera may have an inspection mode. Under inspection mode, the rotatable camera may automatically rotate the camera shot along the default path of tour of inspection (such as the initial position, 0°, and the turning position, 135°) to change the frame coverage continuously, so as to conduct a tour of inspection among fixed points.

Although such rotatable camera may change the frame coverage automatically, however, the rotatable camera can only conduct a tour of inspection among fixed points and does not actively detect the position of a stranger and monitoring it.

Also, a user is not able to change the tour of inspecting path of the rotatable camera at will as desired.

### SUMMARY OF THE INVENTION

A major object of the invention is to provide a method of configuring and adjusting frame coverage of a rotatable camera by automatically changing the frame coverage of the rotatable camera in real time according to a detection result via easy settings.

To achieve the above object, the invention provides a method of configuring and adjusting frame coverage. The method comprises following steps: a) controlling a rotatable camera to shoot a monitoring environment with different angles to generate a plurality of region images; b) combining the region images into a panoramic image; c) receiving an image-selecting operation for selecting a monitoring place from the monitoring environment among the panoramic image among; d) retrieving a rotating angle information corresponding to the selected monitoring place;) corresponding the rotating angle information to a triggering condition; and f) when determining the satisfaction of the trigger condition, controlling the rotatable camera to rotate according to the rotating angle information, so that a current frame coverage of the rotatable camera comprising the monitoring place.

The invention effectively makes the settings of the frame coverage more intuitive by using the panoramic image to select a monitoring place.

### BRIEF DESCRIPTION OF THE DRAWINGS

FIG. 1 is an architecture diagram of a rotatable camera of the first embodiment in the invention.

FIG. 2 is a flow chart of the method of configuring and adjusting frame coverage for a rotatable camera of the first embodiment in the invention.

FIG. 3A is a first flow diagram of the method of configuring and adjusting frame coverage of the rotatable camera of the second embodiment in the invention.

FIG. 3B is a second flow chart of the method of configuring and adjusting frame coverage of the rotatable camera of the second embodiment of the invention.

FIG. 4 is a schematic diagram of a setting of the rotatable camera in the invention.

FIG. 5 is a schematic diagram of the panoramic image in the invention.

FIG. 6 is a schematic diagram of a setting of the frame coverage in the invention.

FIG. 7 is a schematic diagram of a calculation of the rotating angle information in the invention.

### DETAILED DESCRIPTION OF REPRESENTATIVE EMBODIMENTS

A preferred embodiment in the invention with drawings will be illustrated in details in the following.

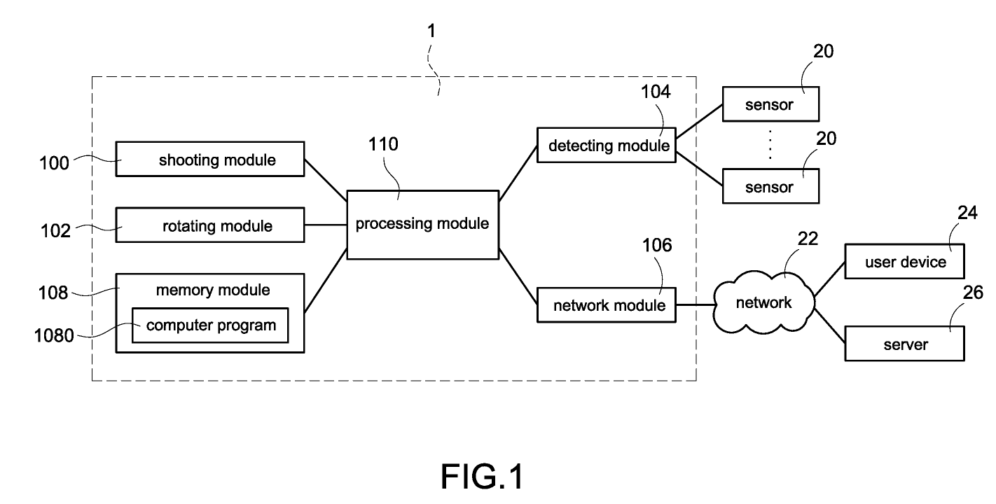

Please refer to FIG. 1. FIG. 1 is an architecture diagram of the rotatable camera of the first embodiment in the invention. As shown in the figure, the rotatable camera 1 of the embodiment mainly includes a shooting module 100, a rotating module 102, a detecting module 104, a network module 106, a memory module 108, and a processing module 110 electrically connected to the above mentioned elements. Preferably, the rotatable camera 1 is a Pan-Tile (PT) camera or a Pan-Tile-Zoom (PTZ) camera.

The shooting module 100 is configured to shoot a monitoring environment, and includes a camera shot and an image sensor. Preferably, the shooting module 100 further includes a zooming module. The zooming module may receive a control from the processing module 110 to change the focal length, such as zoom in or zoom out.

The rotating module 102 receives a control from the processing module 110 to change the orientation of the camera shot of the shooting module 100, such that the shooting module 100 may shoot different regions of the monitoring environment. Preferably, the rotating module 102 includes a rotating platform and an inclined mechanism. The rotating module 102 may receive a control from the processing module 110 to rotate horizontally the rotating platform to change horizontally the orientation of the camera shot, or to incline vertically the inclined mechanism to vertically change the orientation of the camera shot.

The detecting module 104 connects at least one sensor 20, and may receive a sensing signal from the sensor 20 (such as a triggering signal, a brightness signal, a temperature signal, an ultrasonic reflecting signal, or an infrared reflecting signal). The sensor 20 may be a doorbell triggering device, a brightness sensor, a temperature sensor, a motion-detecting sensor (such as infrared sensor (PIR sensor) or ultrasonic sensor), a sound sensor or any combination mentioned above.

The network module 106 connects to a network 22 (such as a local area network or the internet), and may connect to a user device 24 or a server 26 via the network 22. Preferably, the network module 106 connects to the network 22 via a gateway device and/or a router (not shown in the figure). Preferably, the network module 106 is a wireless network module complying with the IEEE 802.11 standard, but should not be limited herein. The memory module 108 is configured to store data.

The processing module 110 is configured to control the rotatable camera 1. Preferably, the processing module 110 may control the rotatable camera 1 to switch between the setting mode and a monitoring mode. Also, under the setting mode, the processing module may execute a function of setting the frame coverage; under the monitoring mode, the processing module 110 may execute a function of adjusting the frame coverage (as will be illustrated in details later).

In another embodiment of the invention, the network module 106 is connected to a user device 24 via a peer-to-peer connection. Specifically, the memory module 108 stores the newest connecting information of the network module 106 (such as a device ID, a MAC address, and an IP address), and the processing module 110 can transmit the newest connecting information to the server 26 by the network module 106 by timed or when updating the connecting information (such as the router redistributing the network address).

Also, the user device 24 stores a camera application program (not shown in the figure) configured to interact with the rotatable camera 1. The user device 24 can retrieve the newest connecting information of the rotatable camera 1 from the server 26 after executing the camera application program, and constructing a peer-to-peer connection with the network module 106 of the rotatable camera 1 according to the retrieved connecting information.

Thereby, even though the rotatable camera 1 adopts the Dynamic IP address, the user device 24 can also connect to the rotatable camera 1 from exterior networks.

In another embodiment of the invention, the rotatable camera 1 further has a gateway function. Specifically, the sensor 20 is a peer-to-peer (P2P) device. The rotatable camera 1 can construct a peer-to-peer connection with the sensor 20 via the detecting module 104. Next, the sensor 20 may receive a control from the rotatable camera 1 (for example, a user can operate the user device 24 to be connected to the rotatable camera 1, and controls the sensor 20 via the rotatable camera 1) via the constructed peer-to-peer connection, or transmits a sensing signal to the rotatable camera 1.

In another embodiment of the invention, the memory module 108 further stores a plurality of webpages. The processing module 110 can provide a connecting service of the webpages via the internet module 106 when detecting the connecting demand from the user device 24, wherein the webpages are configured to provide related information for the sensor 20 or related information for the rotatable camera 1, or receiving an operation from a user (such as an image-selecting operation, a sensor-selecting operation, or a zooming setting operation which will be mentioned later).

In another embodiment of the invention, the user device 24 can construct a network connection(such as the peer-to-peer connection mentioned before) with the rotatable camera 1 after executing the camera application program, and conducts interactions with the rotatable camera 1 via the constructed network connection.

Specifically, the user device 24 can retrieve the related information of the sensor 20 or the related information of the camera 1 from the automatic camera 1 via the network connection after executing the camera application program. Or, the user device 24 can show a graphical user interface (GUI) after executing the camera application program, and receiving the operation(such as an image-selecting operation, a sensor-selecting operation, or a zooming setting operation mentioned later) from the user via the GUI, and transmits the received operation from the user to the rotatable camera 1 (such as generating a corresponding command according to the operation of the user, and transmitting the command to the rotatable camera 1).

Next, the method of configuring and adjusting frame coverage for a rotatable camera of each embodiment in the invention is illustrated herein. It is worth mentioning that, the method of configuring and adjusting frame coverage for a rotatable camera is implemented by using the rotatable camera shown in FIG. 1. Furthermore, the memory module 108 further stores a computer program 1080. The computer program 1080 includes computer-executable codes. After the processing module 110 executing the computer program 1080, each step of the method of configuring and adjusting frame coverage for a rotatable camera of each embodiment in the invention can be executed.

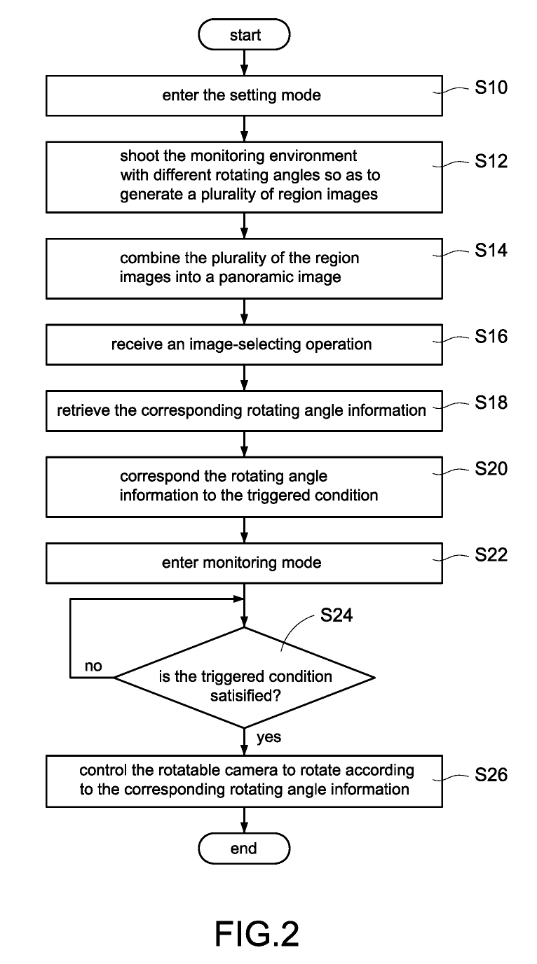

Continue to refer to FIG. 2. FIG. 2 is a flow chart of the method of configuring and adjusting frame coverage for a rotatable camera of the first embodiment in the invention. The method of configuring and adjusting frame coverage for a rotatable camera of the embodiment includes the following steps.

Step S10: the processing module 110 controls the rotatable camera 1 entering a setting mode. Preferably, the processing module 110 controls the rotatable camera 1 to enter the setting mode when receiving a command to entering the setting mode from the user device 24 via the network module 106.

Step S12: the processing module 110 controls the rotatable camera 1 to respectively shoot different regions of the monitoring environment by different angles to generate a plurality of region images corresponding respectively to different regions.

For example, the processing module 110 can control the rotating platform of the rotating module 102 to rotate clockwise for 120° to link up the camera shot of the shooting module 100 changing the orientation continuously, and shoots a plurality of region images during the process of rotation.

Step S14: the processing module 110 combines the shot plurality of region images into a panoramic image. Preferably, the processing module 110 combines the plurality of region images in sequence according to the sequence of shooting of the plurality of region images. Thereby, the panoramic image after completing the combination can reveal the distribution of the plurality of regions of the monitoring environment.

Next, the processing module 110 can transmit to and show the panoramic image on the user device 24 via the network module 106

Step S16: the processing module 110 receives the image-selecting operation by a user via the network module 106 and the user device 24. The image-selecting operation selects images situated at the monitoring places of the monitoring environment among the showed panoramic images.

Preferably, the user device 24 can generate a corresponded image-selecting command according to the received image-selecting operation after receiving the image-selecting operation, and transmits to the rotatable camera 1. Thereby, the processing module 110 of the rotatable camera 1 can know the selected image by the user via the received image-selecting command.

Step S18: the processing module 110 retrieves the rotating angle information corresponding to the selected image (i.e. the monitoring place).

Preferably, the processing module 110 calculates the rotating angle information corresponding to the selected image according to the position corresponding to the selected image (i.e. the monitoring place selected by the user) among the panoramic image and the predetermined angle (including the horizontal rotating angle and the vertical inclined angle) in the step S12.

Step S20: the processing module 110 corresponds the retrieved rotating angle information to the triggering condition. Specifically, the processing module 110 revives a user operation via the network module 106 and the user device 24, and corresponds the retrieved rotating angle information to the specific triggering condition (such as a triggered doorbell, an opened door or window, a temperature higher than a predetermined temperature, a variation of brightness larger than the predetermined variation of brightness, or the coming of the predetermined time) to complete the setting according to the received operation.

Step S22: the processing module 110 controls the rotatable camera 1 entering the monitoring mode. Preferably, the processing module 110 controls the rotatable camera 1 to enter the monitoring mode when receiving the command of entering the monitoring mode from the user device 24 via the network module 106.

Under the monitoring mode, the rotatable camera 1 can continuously shoot the particular region of the monitoring environment (such as a doorway), or shoots a plurality of regions in turns along the predetermined tour of inspecting path.

Step S24: the processing module 110 determines if the triggering condition is satisfied during the monitoring process. If the processing module 110 determines the satisfaction of the triggering condition, executing the step S26; if not, executing again the step S24.

Step S26: when the processing module 110 determines the satisfaction of the triggering condition, retrieves a rotating angle information corresponding to the satisfied triggering condition, and controls the rotatable camera 1 to rotate according to the retrieved rotating angle information, such that the current frame coverage of the rotatable camera 1 covers the monitoring place (i.e. the monitoring place selected in step S16).

The invention can effectively let the settings of the frame coverage more intuitive by using the panoramic image to provide users of selecting monitoring places, so as to effectively enhance user experiences.

Also, the invention automatically adjusts the frame coverage according to the satisfied triggering condition, which can effectively conduct monitoring to the particular monitoring place automatically when the event happens.

It is worth mentioned that, although in the embodiment the rotatable camera 1 shoots a particular region or a plurality of regions under the monitoring mode, but should not be limited herein.

In another embodiment of the invention, when the rotatable camera 1 determines no triggering condition is satisfied under the monitoring mode, the shooting will not be conducted, and only when the triggering condition is satisfied will it adjust the frame coverage automatically and shooting the monitoring place.

Thereby, the invention can effectively reduce the time length of shooting videos and further reducing the amount of data of the generated monitoring videos via stopping recording when there is no event detected (i.e. not any triggering condition is satisfied), and starting recording when an event is detected.

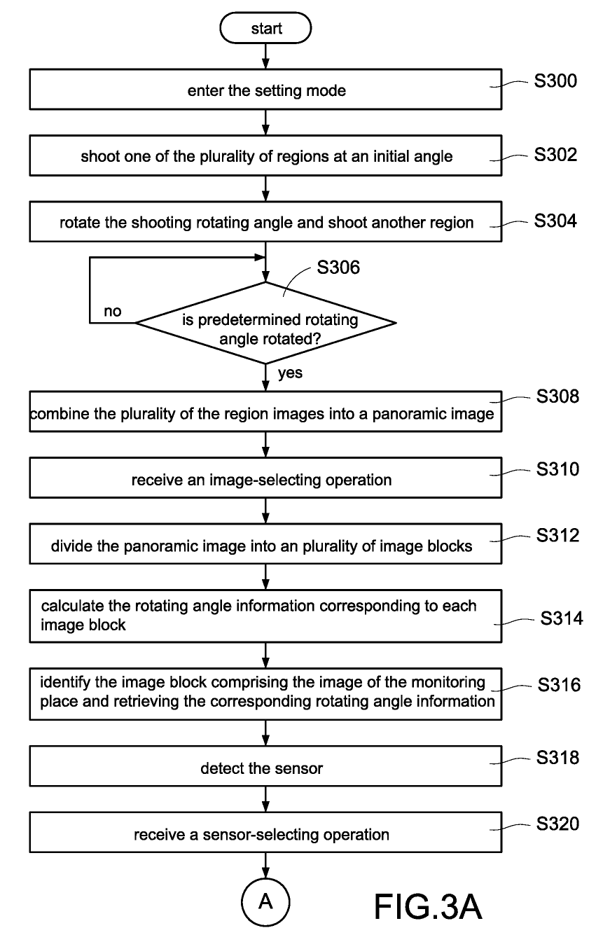

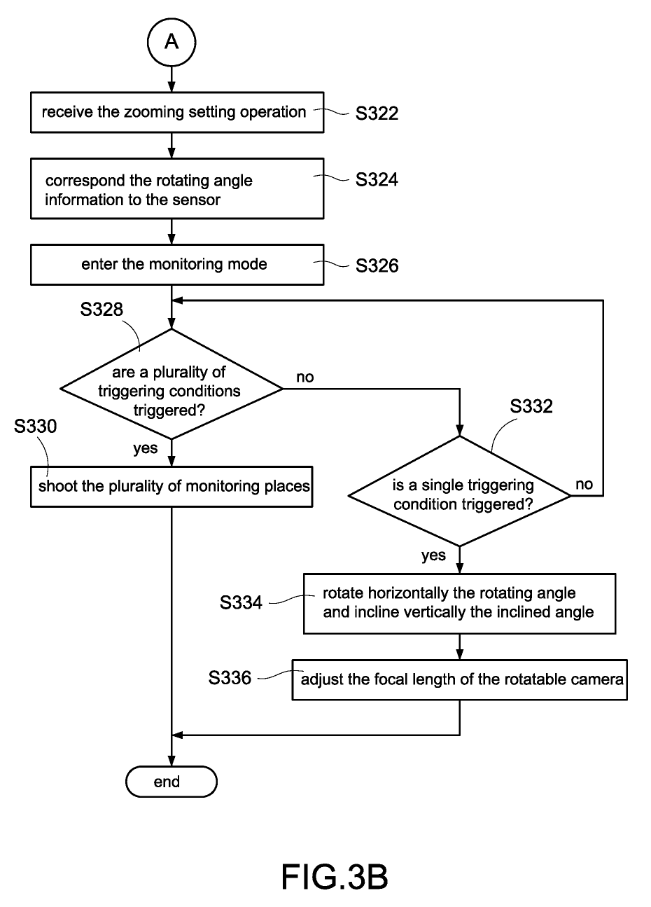

Please also refer to FIG. 3A and FIG. 3B. FIG. 3A is a flow chart of the method of configuring and adjusting frame coverage of the first rotatable camera of the second embodiment in the invention. FIG. 3B is a flow chart of the method of configuring and adjusting frame coverage of the second rotatable camera of the second embodiment of the invention. In the embodiment, the triggering condition is the trigger of the sensor 20. The method of configuring and adjusting frame coverage for a rotatable camera of the embodiment includes the following steps.

Step S300: the processing module 110 controls the rotatable camera 1 entering the setting mode.

Step S302: the processing module 110 controls the rotatable camera 1 to shoot one of the plurality of regions of the monitoring environment at the initial angle (such as 0°), and generating a region image.

Step S304: the processing module 110 controls the rotatable module 102 to rotate a predetermined shooting rotating angle, and controls the shooting module 100 to shoot another region of the monitoring environment after rotation, so as to generate another region image.

Preferably, the shooting rotating angle is not larger than the viewable angle of the frame coverage of the shooting module 100. Thereby, the edge of the two region images of the shooting angle spacing the shooting rotating angle will be continuous or the same, and will be beneficial to the subsequent combining process.

Step S306: the processing module 110 determines if the rotating module 102 already rotates the predetermined rotating angle, wherein the shooting rotating angle is less than the predetermined rotating angle.

Preferably, the predetermined rotating angle is the maximum rotating angle in which the rotating module 102 can rotate (such as the maximum angle the rotating platform can rotate or the maximum angle the inclined mechanism can incline). Or, the predetermined rotating angle is set by a user according to the size of the monitoring environment and the viewable angle of the frame coverage of the shooting module 100.

If the processing module 110 determines the rotating module 102 already rotates the predetermined rotating angle, then executing the step S308. Otherwise, executing again the step S304, so as to shoot another region.

Step S308: the processing module 110 combines the images of the plurality of regions into a panoramic image. Specifically, the processing module 110 conducts combinations in sequence on the images with continuous edges or the same plurality of regions, so as to obtain a panoramic image corresponding to the complete monitoring environment.

Step S310: the processing module 110 receives a plurality of image-selecting operations via the user device 24, wherein each image-selecting operation respectively selects different monitoring places in the monitoring environment among the panoramic image shown on the user device 24.

Step S312: the processing module 110 divides the panoramic image into a plurality of image blocks.

Step S312: the processing module 110 calculates rotating angle information corresponding to each image block.

Preferably, the processing module 110 calculates rotating angle information corresponding to each image block according to the predetermined rotating angle, the viewable angle of the panoramic image, and positions corresponding to each image block among the panoramic image.

It is worth mentioning that, the viewable angle of an image is the range of the viewing angle which can be demonstrated in the image. For example, if the viewable angle of the image is 120°, the field of view which can be demonstrated in the image is to regard the photographer (such as the rotatable camera 1) as the center of the circle, and with the range of 120° as total.

Step S316: the processing module 110 respectively identifies image blocks comprising each monitoring place selected by the user according to the plurality of image-selecting operations, and respectively calculates the rotating angle information corresponding to each image block, wherein the rotating angle information includes a horizontal rotating angle and a vertical inclined angle.

It is worth mentioning that, although in the embodiment, the step S312, S314 are executed after the step S310, but it can also be revised to execute the step S312, S314 before the step S310. For example, the processing module 110 can first divide the panoramic image in to a plurality of regions and calculates the corresponding rotating angle information, and then receives a plurality of image-selecting operation. That is to say, how the processing module 110 divides the plurality of image blocks is irrelevant to the plurality of image-selecting operations.

Step S318: the processing module 110 detects and connects the sensor 20 set up in the monitoring environment via a detecting module 20. Preferably, the processing module 110 scans the sensor 20 in the monitoring environment using a wireless radio frequency (RF) via the detecting module 20, and constructs a connection (such as a peer-to-peer connection) to the scanned sensor 20.

Step S320: the processing module 110 receives the plurality of sensor-selecting operations of the user via the network module 106 and the user device 24. Preferably, the processing module 110 can transmit an identifying information of the detected sensor 20 to show on the user device 24, or shows the identifying information of the detected sensor 20 on a webpage provided by the network module 106, so as to provide the user to select the plurality of sensors 20 via operating the camera application program or the webpage.

Step S322: the processing module 110 receives the zooming setting operations from the user via network module 106 and the user device 24.

Preferably, the rotating angle information further includes a set of zooming value. The zooming setting operation corresponds to the particular image-selecting operation, and can change the size of frame coverage of the shooting module 100. Also, after retrieving the corresponding rotating angle information (i.e. the step S316), the processing module 110 can operate and set the zooming value of the rotating angle information according to the zooming setting, such that the shooting module 100 automatically change the focal length when shooting the region corresponding to the rotating angle information.

It is worth mentioning that, although in the embodiment, the step S318 is executed after the step S316, it can also be revised to execute the step S318, S320, S322 before the step S316. For example, the processing module 110 can simultaneously execute the step S318 while shooting the region image (i.e. the steps S302-S306), and simultaneously executes the step S320, S322 while executing the step S310, so as to simultaneously receive the image-selecting operation, the sensor-selecting operation, and the zooming setting operation.

Step S324: the processing module 110 corresponds respectively the retrieved plurality of rotating angle information to the selected plurality of sensors 20.

Step S326: the processing module 110 controls the rotatable camera 1 into the monitoring mode.

Step S328: the processing module 110 determines if there are plurality of sensors 20 been triggered at the same time (i.e. the plurality of triggering conditions are satisfied).

Preferably, the processing module 110 determines if the plurality of sensors 20 been triggered according to the plurality of sensing signals emitted by the plurality of sensors 20.

If the processing module 110 determines the plurality of sensors 20 been triggered simultaneously, then executes the step S330. Otherwise, the processing module 110 executes the step S332.

Step S330: the processing module 110 retrieves the plurality of rotating angle information corresponding to the triggered plurality of sensor 20, controls the rotatable camera to shoot the plurality of monitoring places simultaneously or in sequence according to the plurality of rotating angle information.

Preferably, if the processing module 110 determines the plurality of monitoring places are close and can be covered in the same frame coverage by the rotatable camera 1 simultaneously, the processing module 110 calculates a set of calibrated rotating angle information (such as calculating the middle value or the average value of the plurality of rotating angle information) according to the retrieved plurality of rotating angle information, and controls the rotatable camera 1 to rotate according to the calibrated rotating angle information, such that the current frame coverage of the rotatable camera 1 covers the corresponding plurality of monitoring places simultaneously.

Specifically, the calibrated rotating angle information can include a calibrated rotating angle, a calibrated inclined angle, and a calibrated zooming value. The processing module 110 calculates the calibrated rotating angle, the calibrated inclined angle, and the calibrated zooming angle according to the rotating angle, the inclined angle, and the calibrated zooming value of the plurality of rotating angle information.

Also, the processing module 110 controls the camera shot of the shooting module 100 of the rotatable camera 1 rotating horizontally the calibrated rotating angle, inclining vertically the calibrated inclined angle, and adjusting the focal length of the rotatable camera 1 according to the calibrated zooming value.

If the processing module 110 determines the distances between the plurality of monitoring places are too far, and cannot be covered simultaneously in the same frame coverage of the rotatable camera 1, the processing module 110 calculates the shooting path according to the retrieved plurality of rotating angle information, and controls the rotatable camera 1 to shoot the plurality of monitoring places in turn along the shooting path.

Specifically, the processing module 110 controls the camera shot of the shooting module 100 of the rotatable camera 1 to rotate horizontally the rotating angles of each rotating angle information in order; to incline vertically the inclined angles of each rotating angle information in order; and to adjust the focal length of the rotatable camera 1 in order according to the zooming values of each rotating angle information, so as to shoot the plurality of monitoring places in order.

Step S332: the processing module 110 determines if there is only a single sensor 20 been triggered at the same time (i.e. the single triggered condition is satisfied).

If the processing module 110 determines there is only a single sensor 20 been triggered, executing the step S334. Otherwise, executing the step S328 again.

Step S334: the processing module 110 retrieves rotating angle information corresponding to the sensor 20, and then controls the camera shot of the shooting module 100 of the rotatable camera 1 rotating horizontally with a retrieved rotating angle from the rotating angle information, and inclines vertically a retrieved inclined angle from the retrieved rotating angle information.

Step S336: the processing module 110 can further adjust the focal length of the rotatable camera 1 according to the retrieved zooming value from the rotating information when determining the retrieved rotating angle information including a zooming value, so as to enlarge the image of the monitoring place or to increase the frame coverage.

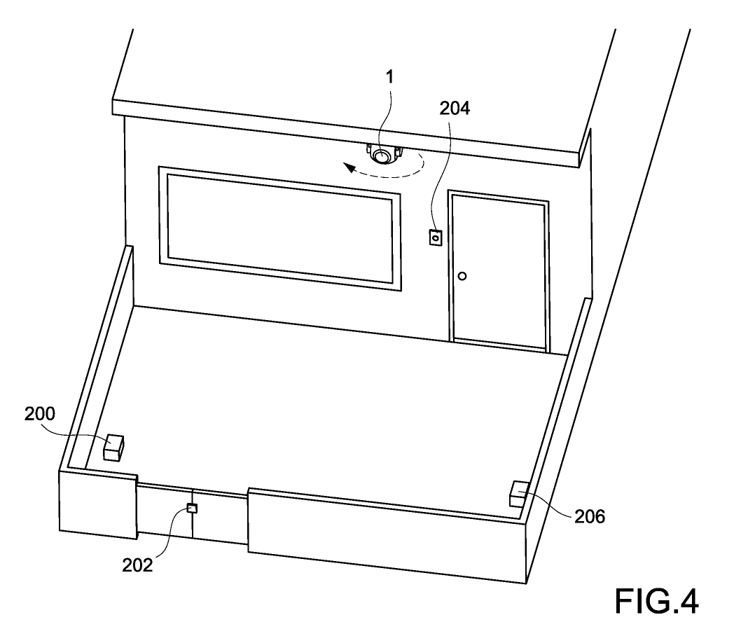

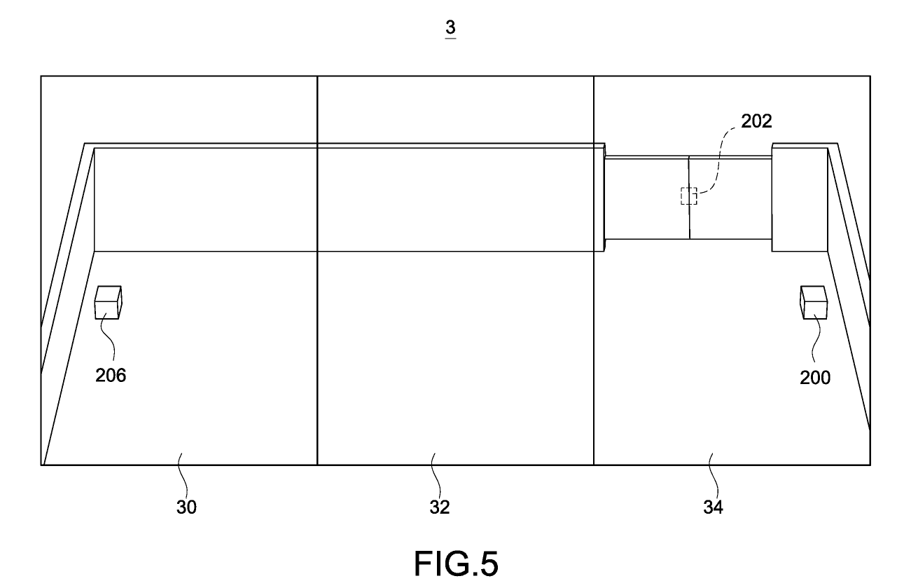

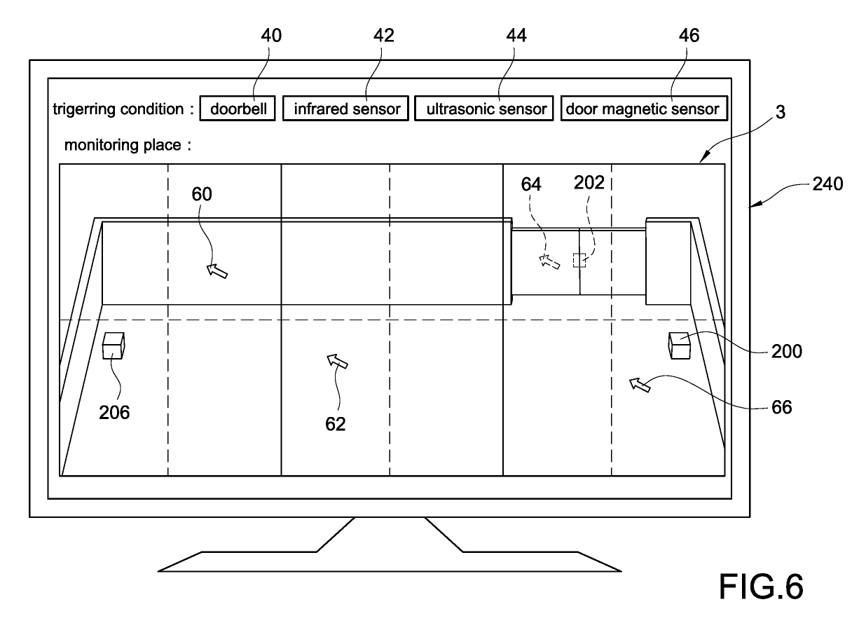

Please refer to FIG. 4 and FIG. 6. FIG. 4 is a schematic diagram of a setting of the rotatable camera in the invention. FIG. 5 is a schematic diagram of the panoramic image in the invention. FIG. 6 is a schematic diagram of a setting of the frame coverage in the invention configured to exemplify the application situations of the method of configuring and adjusting frame coverage for a rotatable camera.

As shown in FIG. 4. In this example, a plurality of sensors 200-206 are respectively an infrared sensor, a door magnetic sensor, a doorbell, and an ultrasonic senor, respectively installed at different monitoring places of the monitoring environment. The rotational camera 1 is installed above the front door to monitor the whole monitoring environment.

As shown in FIG. 5, the rotatable camera 1 shoots respectively a plurality of regions of the monitoring environment with different rotating angles under the setting mode, so as to generate a plurality of region images 30-34. Next, the rotatable camera 1 can conduct a pre-image processing (such as distortion compensation, an image straightening, or a cropping) to the region images 30-34, and then combines the processed region images 30-34 into a panoramic image 3.

In addition, the rotatable camera 1 can further detect the plurality of sensors 200-206 installed in the monitoring environment under the setting mode, constructing a connection to the detected sensor and retrieving the identifying information.

Next, the rotatable camera 1 transmits the identifying information of the panoramic image 3 and the identifying information of the plurality of sensors 200-206 to the user device 24.

As shown in FIG. 6, the user device 24 can show a plurality of selections 40-46 on a screen 240 according to the received plurality of identifying information, wherein the plurality of selections 40-46 can show respectively the identifying information of the corresponding plurality of sensors 200-206 (for example, the selection 40 shows the identifying information of the sensor 204 “doorbell”; the selection 42 shows the identifying information of the sensor 200 “infrared sensor”; the selection 44 shows the identifying information of the sensor 205 “ultrasonic sensor”; the selection 46 shows the identifying information of the sensor 202 “door magnetic sensor”). Also, the user device 24 can also shows the panoramic image 3 on the screen 240 in a clickable way.

Next, a user can enter an image-selecting operation, a sensor-selecting operation and/or a zooming setting operation via the user device 24. Specifically, a user can select a monitoring place 60 (image-selecting operation), and then selects the selection 44 (sensor-selecting operation), so as to correspond the rotating angle information (corresponding to the monitoring place 60) to the sensor 206. A user can also select a monitoring place 62, and then selects the selection 40, so as to correspond the rotating angle information (corresponding to the monitoring place 60) to the sensor 206. A user can also select a monitoring place 66, and then selects the selection 42, so as to correspond the rotating angle information (corresponding to the monitoring place 66) to the sensor 200. A user can also select a monitoring place 64, and then selects the selection 46, so as to correspond the rotating angle information (corresponding to the monitoring place 60) to the sensor 202.

In addition, since the monitoring place 64 is farther to the rotatable camera 1 in distance, a user can also further set a zooming value to be 50 mm (zooming setting operation), such that the rotatable camera 1 can automatically switch to a longer focal length when shooting the monitoring place 64, so as to obtain an enlarged image of the monitoring place 64.

Thereby, when any one of the sensors 200-206 is triggered (such as the detection of a person by the infrared sensor or the ultrasonic sensor, a pressing of the doorbell, or an opening of the gate), the rotatable camera 1 can automatically change the frame coverage to shoot the corresponding monitoring places 60-66.

Also, a user only needs to click the monitoring places 60-66 among the panoramic image 3, and can simply complete the setting of the frame coverage of the rotatable camera 1, thus the degree of difficulty in settings can be effectively reduced.

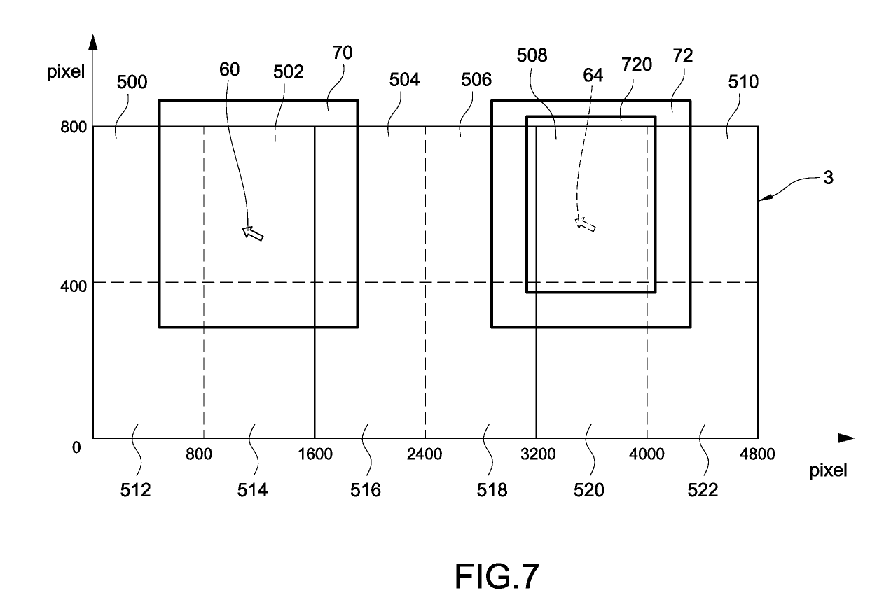

Continue to refer to FIG. 5 and FIG. 7 simultaneously. FIG. 7 is a schematic diagram of a calculation of the rotating angle information in the invention configured to exemplify the retrieving ways for the rotating angle information.

In the example, the movable angle (i.e. the predetermined rotating angle) of the rotatable camera 1 is 240° horizontally and 90° vertically. Also, the rotatable camera 1 shoots the region image 30 when rotating 40° horizontally and inclining 20° vertically; shoots the region image 32 when rotating 120° horizontally and inclining 20° vertically; shoots the region image 34 when rotating 200° horizontally and inclining 20° vertically.

The single frame coverage of the rotatable camera 1 (i.e. the viewable angles of each region image 30-34) is 80° horizontally and 40° vertically. The size of the panoramic image 3 is 4800 pixels×800 pixels, and the viewable range is 240° horizontally and 40° vertically.

As shown in FIG. 7, the rotatable camera 1 can divide each region image 30-34 respectively into 4 image blocks, so as to divide the panoramic image into 12 image blocks 500-522.

Next, the rotatable camera 1 calculates the rotating angle information corresponding to each image blocks 500-522. Specifically, the rotatable camera 1 calculates the rotating angle information corresponding to the frame coverage of the covered image blocks 500-522 (such as the frame coverage 70, 72, 720).

Preferably, the rotatable camera 1 first views a pixel as a unit to coordinate the panoramic image 3. Next, the rotatable camera 1 calculates the coordinate of the central point of the particular image blocks; calculates the ratio between the coordinate and the coordinate range of the panoramic image 3; and calculates the rotating angle corresponding to the particular image block according to the calculated ratio and the viewable range of the panoramic image 3.

Taking the rotating angle information corresponding to the image block 502 as an example, the rotatable camera 1 calculates the coordinate of the central point of the image block 502 (1200,600); calculates the ratio (1/4, 3/4) between the coordinate and the size of the panoramic image 3 (4800,800); and then calculates the corresponding rotating angle information (horizontal 60°, vertical 30°) according to the calculated ratio and the viewable range of the panoramic image 3 (horizontal 240°, vertical 40°). Thereby, the rotatable camera 1 can adjust the current frame coverage to cover the frame coverage 70 of the image block 502 via rotating 60° horizontally and inclining 30° vertically. Furthermore, when the user selects the monitoring place 60, the rotatable camera 1 can identify the monitoring place 60 situated in the image block 502, and views the rotating angle information corresponding to the image block 502 directly as the rotating angle information of the monitoring place 60.

Taking the rotating angle information corresponding to the image block 508 as an example, the rotatable camera 1 calculates the coordinate of the central point of the image block 508 (3600,600); calculates the ratio (3/4 , 3/4) between the coordinate and the size of the panoramic image 3 (4800,800); and then calculates the corresponding rotating angle information (horizontal 180°, vertical 30°) according to the calculated ratio and the viewable range of the panoramic image 3 (horizontal 240°, vertical 40°). Thereby, the rotatable camera 1 can adjust the current frame coverage to cover the frame coverage 72 of the image block 508 via rotating 180° horizontally and inclining 30° vertically.

Furthermore, the rotatable camera 1 can also enhance the focal length according to the zooming value of the rotating angle information, and enlarges the image of the image block 508 via shrinking the frame coverage 72 to be the frame coverage 720. Thereby, when a user selects the monitoring place 64, the rotatable camera 1 can identify the monitoring place 64 situated in the image block 508, and views the rotating angle information corresponding to the image block 508 directly as the rotating angle information of the monitoring place 64.

Although in the example mentioned above, the rotatable camera 1 views the rotating angle information corresponding to the image block directly as the rotating angle information of the monitoring place, but it should not be limited herein.

In another embodiment of the invention, the rotatable camera 1 retrieves the coordinate of the monitoring place selected by a user; calculates the ratio between the coordinate and the viewable range of the coordinate of the panoramic image 3; and calculates the corresponding rotating angle information according to the calculated ratio and the viewable range of the panoramic image 3.

The examples are only preferred specific embodiments of the invention, and are not thence restrictive to the scope of claims of the invention. Therefore, those who apply equivalent changes incorporating contents from the invention are included in the scope of the invention, as stated herein.

What is claimed is:

1. A method of configuring and adjusting frame coverage comprising:
a) controlling a rotatable camera to shoot a monitoring environment with different angles to generate a plurality of region images;
b) combining the region images into a panoramic image;
c) receiving an image-selecting operation for selecting a monitoring place from the monitoring environment among the panoramic image;
d) retrieving rotating angle information corresponding to the selected monitoring place;
e) corresponding the rotating angle information to a triggering condition; and
f) when determining the satisfaction of the trigger condition, controlling the rotatable camera to rotate according to the rotating angle information, so that current frame coverage of the rotatable camera covering the monitoring place.

2. The method of configuring and adjusting frame coverage as claim 1, wherein the step a) comprises the following steps:
a1) shooting one of the plurality of regions from the monitoring environment with an initial angle to generate the region image; and
a2) controlling the rotatable camera to rotate a predetermined rotating angle, and shooting the another region of the monitoring environment to generate an image of the another region during each rotation of a shooting rotating angle, wherein the shooting rotating angle is less than the predetermined rotating angle, and the edges of the two region images of the shooting angle spacing the shooting rotating angle are continuous or the same.

3. The method of configuring and adjusting frame coverage as claim 1, wherein the step d) calculates the rotating angle information according to a predetermined rotating angle of the rotatable camera and a position corresponding to the monitoring place among the panoramic image.

4. The method of configuring and adjusting frame coverage as claim 3, wherein the step d) comprises the following steps:
d1) dividing the panoramic image into a plurality of image blocks;
d2) calculating respectively the rotating angle information corresponding to each of the image block according to the predetermined rotating angle, a viewable angle of the panoramic image, and the position corresponding to each of the image block among the panoramic image; and
d3) identifying the image block comprising an image of the monitoring place and retrieving the corresponding rotating angle information.

5. The method of configuring and adjusting frame coverage as claim 1, wherein the step e) comprising the following steps:
e1) detecting a plurality of sensors;
e2) receiving a sensor-selecting operation of selecting one of the sensors; and
e3) corresponding the rotating angle information to the selected sensor, wherein the step f) determines if the triggering condition is satisfied according to a sensing signal emitted by the sensor.

6. The method of configuring and adjusting frame coverage as claim 1, wherein the rotating angle information comprises a rotating angle and an inclined angle, the step f) controls the camera shot of the rotatable camera to rotate horizontally with the rotating angle and inclining vertically with the inclined angle.

7. The method of configuring and adjusting frame coverage as claim 6, wherein the rotating angle information further comprises a zooming value, before the step e), the method comprises a step e0): receiving a zooming setting operation to set the zooming value, wherein a step g) is comprised after the step f): adjusting the focal length of the camera according to the zooming value.

8. The method of configuring and adjusting frame coverage as claim 1, wherein after the step e) and before the step f), the method further comprises step f0: repeating executing the step c) till the step e), so as to select a plurality of the monitoring places and respectively corresponding the rotating angle information to the plurality of the triggered condition.

9. The method of configuring and adjusting frame coverage as claim 8, wherein the method of configuring and adjusting frame coverage further comprises a step h) as following: according to the rotating angle information corresponding to the triggered conditions to calculate a calibrated rotating angle information when determining the plurality of the triggered conditions been satisfied, and controlling the rotatable camera to rotate according to the calibrated rotating angle information, such that the current frame coverage of the rotatable camera covering simultaneously the monitoring places corresponding to the satisfied plurality of the triggered conditions.

10. The method of configuring and adjusting frame coverage as claim 8, wherein the method of configuring and adjusting frame coverage further comprises a step i) as following: calculating a shooting path according to the rotating angle information corresponding to the triggered conditions when determining the plurality of the triggered conditions been satisfied, and controlling the rotatable camera to rotate along the shooting path, so as to shoot in turn the monitoring places corresponding to the satisfied plurality of the triggered conditions.
